(19) United States
(12) Patent Application Publication
(10) Pub. No.: US 2006/0174469 A1
(43) Pub. Date: Aug. 10, 2006

(54) Method for producing a cam for a clutch, device for milling the contour surfaces of the cam, and device for shortening the cam journal

(75) Inventors: Winfried Kruger, Parchim (DE); Torsten Baustian, Cirvitz (DE); Stefan Beetz, Crivitz (DE)

Correspondence Address: NORRIS, MCLAUGHLIN & MARCUS, 875 THIRD AVE, 18TH FLOOR, NEW YORK, NY, 10022, US

(73) Assignee: PNP automotive GmbH, Crivitz (DE)

(21) Appl. No.: 10/527,933

(22) PCT Filed: Sep. 23, 2003
(86) PCT No.: PCT/DE03/03166

§ 371 Date: Nov. 15, 2005

(30) Foreign Application Priority Data
Sep. 24, 2002 (DE) 102 44 488.9

(51) Int. Cl. B23P 17/04

(52) U.S. Cl. 29/592

(57) ABSTRACT

Cams for clutches have been produced by a machining in a highly complex manner. To reduce the corresponding production costs, the cam (6) is first formed or deformed in such a way that the outer surface (13) has its finished measures and the cam journal (18) has an overlength. Mechanical machining is carried our, the finished outer surface (13) being used as an abutment for the clamping device. After the mechanical machining, the overlength of the cam journal (18) is twisted off. A novel device is provided for the mechanical processing of the cam (6), and a novel rotary device is provided for twisting of the overlength of the cam journal (18)

The inventions relate to the production of a clutch according to the preamble of claims 1, 5, and 7. Such clutches are used in conjunction with two-part stabilizers in the automotive industry.

Generally, each axle of an automobile is equipped with a stabilizer. The stabilizer operates essentially like a torsion rod and is arranged parallel to the vehicle axle, wherein both ends are attached to a respective wheel suspension. The stabilizer prevents or significantly attenuates the transmission of a rolling motion that is caused by the road conditions and originates from the wheels to the vehicle. As a result, the driving performance becomes more stable and therefore also safer on uneven road surfaces and in curves.

One-part stabilizers are adapted for particular road conditions and therefore have only limited applications.

Split stabilizers are always used when vehicles are designed for both road and off-road travel. A stabilizer of this type is described, for example, in DE 100 12 915 A1. This stabilizer consists of a first stabilizer element and a second stabilizer element, which are connected with each other by a clutch.

The clutch includes a tubular outer swivel element, which is non-rotatably connected with one of the stabilizer elements, and an inner swivel element, which is connected as one-piece with the other stabilizer element. The outer swivel element and the inner swivel element each have a claw, whereby the claws are located on a radial plane. Two claws of an axially displaceable claw sleeve engage between these two claws to form a positive connection. The two claws of the swivel elements and the two claws of the coupling sleeve each have complicated and matching radial conical surfaces.

Due to manufacturing issues, the tubular outer swivel element and its inwardly oriented cam are manufactured as separate parts and are welded together. The tubular swivel element has a radial through opening in the shape of an ellipse, and the cam includes a matching elliptical pin. The cam and the outer swivel element are connected by pushing the cam journal from the interior space of the tube through the radial through opening of the outer swivel element and subsequently welded together flush from the outside.

The cam is machined as a separate part by metal cutting. Initially, a swivel element is produced in form of a sleeve and consisting of a clamping shank and a cam section. The diameter of the cam section corresponds to the outside diameter of the outer swivel element of the clutch. This cam section is then machined in a contour milling process to an outside diameter that corresponds to the inside diameter of the outer swivel element of the clutch, with two opposing elliptical pins remaining. The cam section is then milled in a special way in the region between the two pins, leaving two opposing cams, each having a pin. The two cams are finally separated from the clamping shank in a lathe. The clamping shank is discarded.

This manufacturing process is very time-consuming, because the manufacturing process involves exclusively metal cutting, and is also very material-intensive, because a large proportion of material is removed, and because a relatively large clamping shank is required for the manufacture of only two cams that later becomes obsolete.

Disadvantageously, the cylindrical surface of the cam can also not be milled with the required accuracy. This affects primarily the transition region from the cylindrical surface to the elliptical pin. The outer surface of the cam then does not suitably match the cylindrical surface of the tubular outer swivel element, causing misalignment of the cam after welding. Due to this misalignment, the surfaces of the conical surfaces of the cam also do not match the conical surfaces of the corresponding claw of the clutch sleeve, so that the force in these regions is transmitted across points or lines instead of across an area. This affects and degrades the spring rate of the entire stabilizer.

It is the therefore an object of the invention to simplify the manufacture of the cam while also improving the quality of the outer surface of the cam.

It is another object to develop a milling and turning device for machining of a cam several times.

The object regarding the method is solved by the characterizing features of claim 1.

Advantageous embodiments are recited in the dependent claims 2 to 4.

The object regarding the device is solved by the characterizing features of claims 5 and 7.

Advantageous embodiments are recited in the dependent claims 6 and 8.

The inventions eliminate the aforedescribed disadvantages of the prior art.

The novel methods and the two novel devices significantly reduce the manufacturing costs of a cam. This relates not only to the manufacturing time, but also to the required quantity of material. A significant quantity of material is saved by largely forming the cam and only slightly machining the cam by metal cutting. In addition, the cam can be milled by extending the length of only the relatively small cam journal, so that later only a relatively small clamped section needs to be discarded.

Particularly advantageous, however, is the improved quality. A cylindrical outer surface of the cam is produced already in the prototyping or reshaping operation. The cylindrical outer surface has a high quality, which makes it suitable as a reference surface for the subsequent mechanical machining. All additional functional dimensions, such as a particular the lateral conical surfaces of the cam, can also be maintained, which is a prerequisite to transmit the torque over a surface area in the clutch.

Advantageously, the cam is formed by cold-working, which improves the dimensional accuracy and facilitates subsequent machining.

A particularly high quality of the cylindrical outer surface of the cam is obtained by soft-annealing the cam after forming, which eliminates strain, and by phosphatizing and calibrating the cylindrical outer surface, which improves the accuracy.

Advantageously, the devices for milling and shortening can be constructed as multiple clamping fixtures. This increases the manufacturing efficiency.

The inventions will be described in more detail with reference to an embodiment. It is shown in:

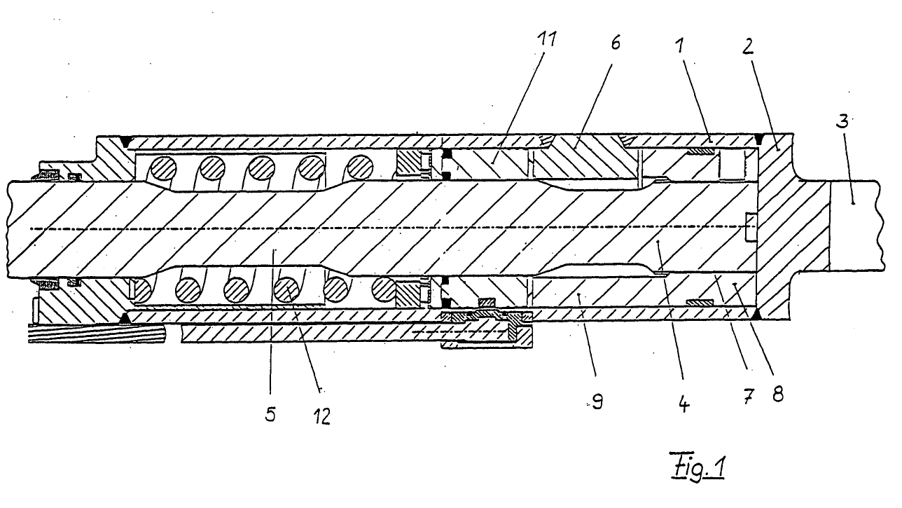

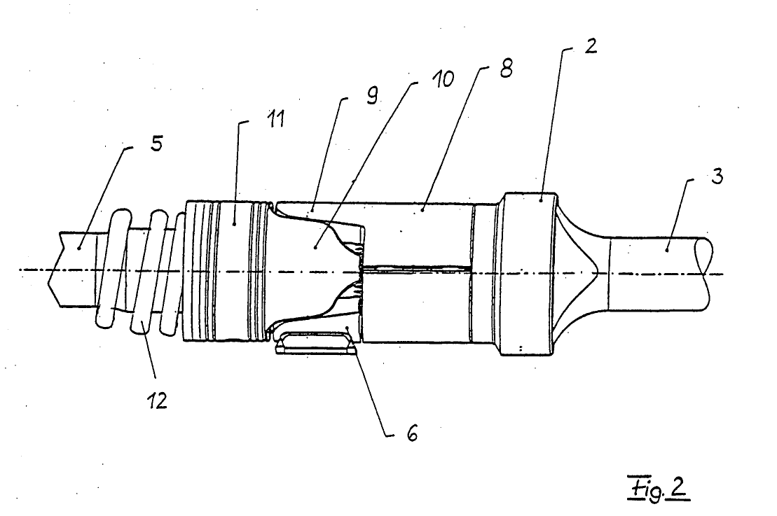

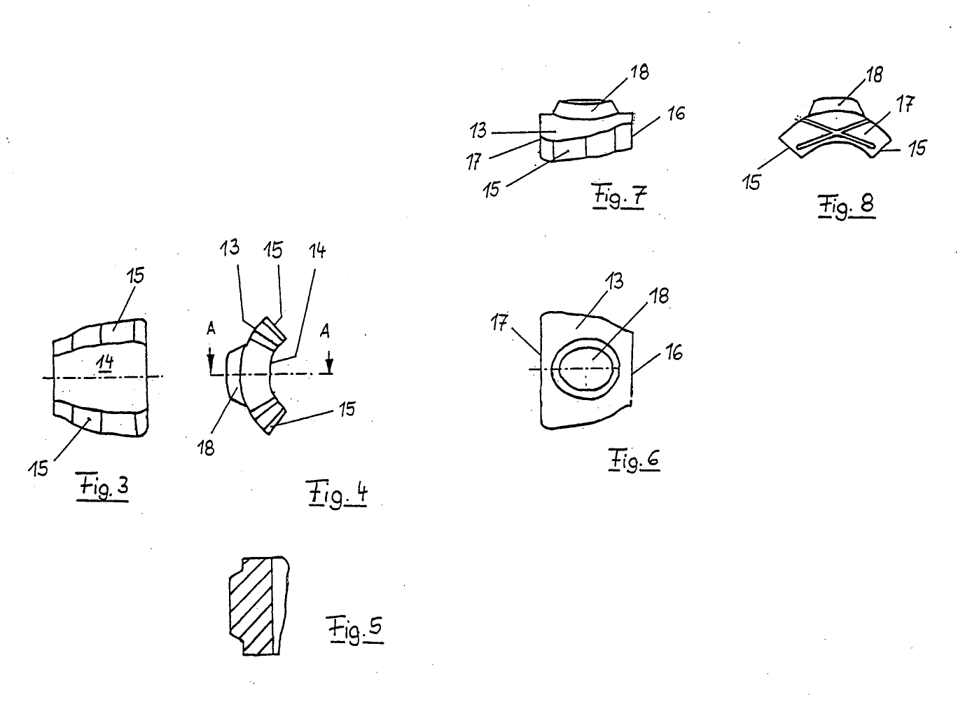

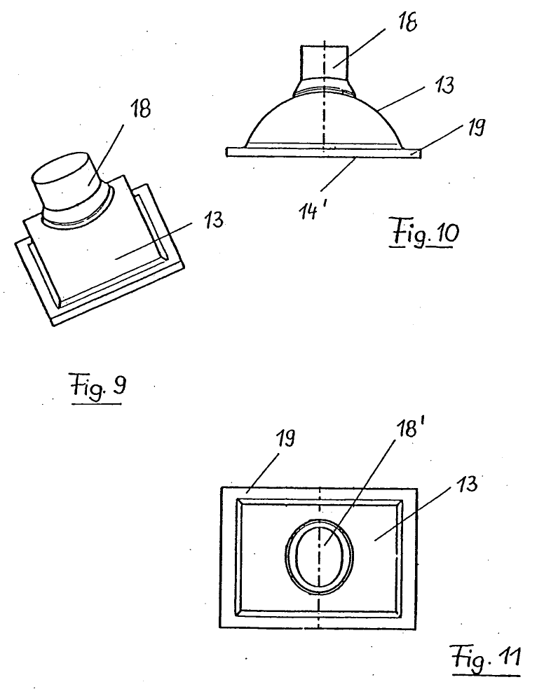

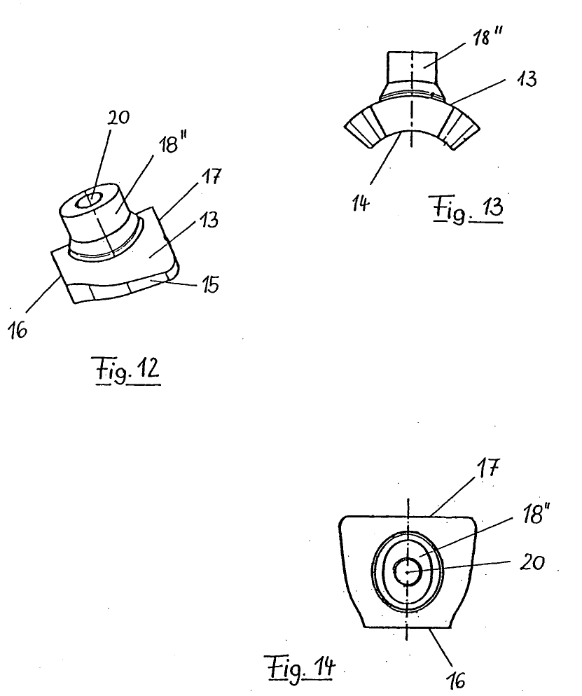

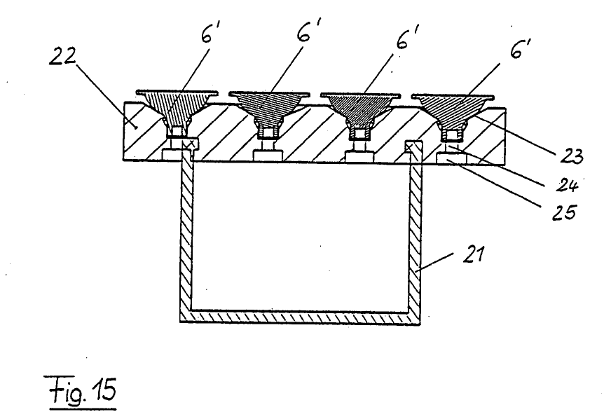

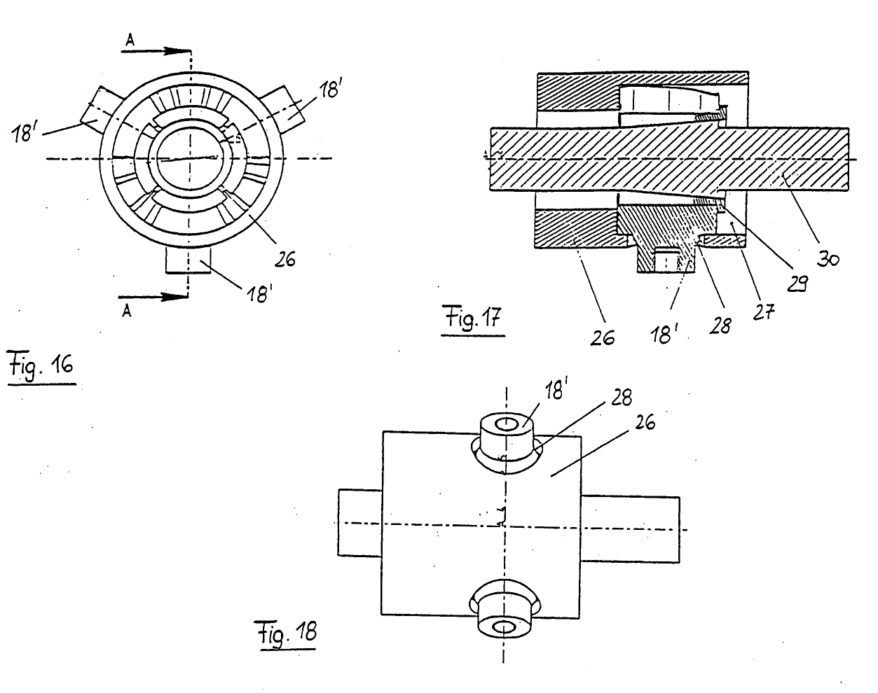

FIG. 1: a clutch in cross-sectional view,

FIG. 2: a view of the interior components of the clutch,

FIG. 3: a view of the cam of the outer swivel element of the clutch,

FIG. 4: a different view of the cam,

FIG. 5: the cam of FIG. 4 in a cross-sectional view,

FIG. 6: another view of the cam,

FIG. 7: another view of the cam,

FIG. 8: another view of the cam,

FIG. 9: a view of a prototyped or reshaped cam,

FIG. 10: another view of a prototyped or reshaped cam,

FIG. 11: another view of a prototyped or reshaped cam,

FIG. 12: a view of a cam as a blank,

FIG. 13: another view of a cam in form of a blank,

FIG. 14: another view of a cam in form of a blank,

FIG. 15: device for milling the contour surfaces of the cam,

FIG. 16: a view of a device for shortening the cam journal,

FIG. 17: the device for shortening in a cross-sectional view taken along the line A-A of FIG. 16, and

FIG. 18: a different view of the device for shortening.

The clutch according to FIGS. 1 and 2 has an outer swivel element 1 in form of a tube that is non-rotatably connected via a flange 2 with a first stabilizer element 3, and an inner swivel element 4 formed as a single piece with a second stabilizer element 5. The outer swivel element 1 has a non-rotatable, inwardly oriented cam 6. The inner swivel element 4 is connected via a toothed section 7 to a cam sleeve 8 having a cam 9 that is oriented outwardly from the swivel element 5. The inwardly oriented cam 6 of the outer swivel element 1 and the outwardly oriented cam 9 of the inner swivel element 5 are located on a common radial plane and form between them two opposing clutch spaces. Two conical claws 10 of a clutch sleeve 11, which is arranged for axial movement on the inner swivel element 4, move into engagement in these two clutch spaces. The clutch sleeve 11 is hereby subjected on one side to a force of a pressure spring 12 and on both sides alternatingly to a hydraulic pressure. Accordingly, the force of the pressure spring 12 and the hydraulic pressure acting in the same direction cause a form-fitting engagement between the two cams 6 and 9 of the two swivel elements 1 and 4 and the two conical claws 10 of the clutch sleeve 11. The two stabilizer elements 3 and 5 are then connected with each other non-rotatably and without slippage. This positive engagement is interrupted when the hydraulic pressure applied to the clutch sleeve 11 opposes the force of the pressure spring 12. The clutch sleeve 11 is then displaced by a certain distance, and the two cams 6 and 9 and the claws 10 of the clutch sleeve 11 are no longer in contact, but still mesh. The cams 6, 9 and the claws 10 can then freely rotate relative to each other over a limited angle with slippage, whereafter they again make contact with each other.

The outer swivel element 1 and the cam 6 are each implemented as a separate part and welded together. The outer swivel element 1 has an elliptical opening extending in the axial direction, through which a correspondingly formed cam 6 is inserted from the inside and welded from the outside to the outer swivel element 1. The cam 6 according to FIGS. 3 to 8 has then a segmented form with a cylindrical outer surface 13 matched to the inside diameter of the outer swivel element 1, and a cylindrical inner surface 14 corresponding to the surface of the inner swivel element 4. The cam 6 has two lateral conical surfaces 15 which match the conical surfaces of the claws 10 of the clutch sleeve 11. The respective lengths of the outer surface 13, the inner surface 14 and the two conical surfaces 15 are terminated by a smaller end face 16 that is oriented towards the clutch sleeve 11, and a larger end face 17 that contacts the cam sleeve 11.

An elliptical cam journal 18 with dimensions that match the dimensions of the elliptical opening in the outer swivel element 1 is disposed on the outer surface 13 of the cam 6. The height of the cam journal 18 corresponds to the wall thickness of the tubular outer swivel element 1. Both the cam journal 18 and the opening in the tubular outer swivel element 1 have a conical shape, which results in a V-shaped weld seam.

The cam 6 is manufactured in two process steps.

In a first process steps, a cam 6′, as shown in FIGS. 9 to 11, is prototyped or reshaped either cold or warm. The cam 6′ is here constructed with an extended cam journal 18′. This extension of the cam journal 18′ represents a clamping journal for subsequent machining. Moreover, the surface which later becomes the cylindrical inner surface 14′ is planar or already preformed and provided with a machining edge 19. After prototyping or reshaping, the cam 6′ is soft-annealed to homogenize the structure and phosphatized to reduce the friction of the surface. Finally, a wobble press is used to calibrate the cylindrical outer surface 13 of the cam 6′, producing a finish-machined surface that has the quality of a reference surface for the following mechanical machining.

In the second process steps, the cam 6′ is processed further by metal cutting. The corresponding machining state is shown in FIGS. 12 to 14.

Initially, in a first operation, a radial threaded bore 20 is machined in the extended journal 18′ of the cam 6′ to aid with clamping for the following machining.

In a second operation, the end faces 16, 17 and the lateral conical surfaces are milled. For this operation, several cams 6′ of this type are clamped in a device configured for the milling the contours of the cam 6′, as shown in FIG. 15.

This device consists of a conventional clamping vise 21, which receives a cam tensioning bar 22. The cam tensioning bar 22 has a width that is narrower than the later longitudinal distance between the two end faces 16, 17 of the cam 6′, and a length necessary to receive several cams 6′. To receive several cams 6′, the cam tensioning bar 22 includes several receiving V-blocks 23 arranged in a row, which are each provided with a through bore 24. One cam 6′ is inserted in each of the receiving V-blocks 23 in such a way that the finished cylindrical outer surface 13 comes to rest on the receiving V-block 23, and the lateral conical surfaces 15, the end faces 16, 17, and the cylindrical inner surface 14′ still to be machined are oriented upwardly. A tensioning screw 25 is inserted from the underside of the cam tensioning bar 22 in the through bore of the cam tensioning bar 22 and screwed together with the cam journal 18′ until tensioned. As a result, all outside regions of the cam 6′ to be machined are accessible.

In this clamping arrangement, the lateral conical surfaces 15 and the two end faces 16, 17 are milled to the nominal finished size.

Thereafter, in a third operation, the device for milling the contour surfaces of the cam 6′ is rotated by 90°, and the cylindrical inner surface 14 is also milled to its nominal finished size.

In a fourth operation, the cam journal 18′ is turned off on the lathe to the predefined length.

This operation is performed with a device for shortening the cam journal 18, as illustrated in FIGS. 16 to 18.

This device has a sleeve-like clamping jaw 26. The clamping jaw 26 has an outside diameter that corresponds to the outside diameter of the outer swivel element 1 of the clutch, and an axial through bore 27 with a stepped diameter. The greater diameter of the through bore 27 corresponds to the inside diameter of the outer swivel element 1. The clamping jaw 26 has three openings 28 arranged uniformly around the periphery in a region where the through bore 27 has the greater diameter, with the shape and size of the openings 28 matching the elliptical cam 6′. The device further includes a clamping sleeve 29 which matches the outside diameter of the inner swivel element, and a clamping mandrel 30.

Three of the cams 6′ are clamped in this device, whereby the cams 6′ are inserted through the through bore 27 and positioned with their cam journal 18′ through the radial openings 28 of the clamping jaw 26. All three cams 6′ are non-rotatably clamped in the clamping jaw 26 with the clamping mandrel 30 and the clamping sleeve 29. This device is then received on the clamping mandrel 30 of a lathe between the tips, whereafter the excess length of the three cam journals 18′ is turned off on the lathe.

List of Reference Numerals

1 outer swivel element

2 flange

3 first stabilizer element

4 inner swivel element

5 second stabilizer element

6 cam of the outer swivel element

7 toothed section

8 cam sleeve

9 cam of the inner swivel element

10 claw of the clutch sleeve

11 clutch sleeve

12 pressure spring

13 cylindrical outer surface

14 cylindrical inner surface

15 lateral conical surface

16 small end face

17 large end face

18 cam journal

19 machining edge

20 threaded bore

21 clamping vise

22 cam tensioning bar

23 receiving V-block

24 through bore

25 tensioning screw

26 clamping jaw

27 through bore

28 radial opening

29 clamping sleeve

30 clamping mandrel

1-8. (canceled)

9. Method for producing a cam for a clutch, comprising the steps of
forming the cam (6) in segments and providing a cylindrical outer surface (13), a cylindrical inner surface (14), two lateral conical surfaces (15) and the two end faces (16, 17), disposing a cam journal (18) on the cylindrical outer surface (13) of the cam (6), and milling the inner surface (14), the two conical surfaces (15) and/or the two end faces (16, 17) of the cam (6),
forming the cam (6) on a first process step so that the cylindrical outer surface (13) has its nominal finished size and the cam journal (18) has an excess length,
mechanically machining the cam in a second process step, wherein the cylindrical outer surface (13) of the cam (6) is received and clamped in a clamping device for milling the cylindrical inner surface (14), the two lateral conical surfaces (15) and the two end faces (16, 17), and
turning off the excess length of the cam journal (18″) in a lathe.

10. Method according to claim 9,
wherein forming the cam (6) comprises prototyping or reshaping performed by a cold or warm process.

11. Method according to claim 10, further comprising a step of
soft-annealing the cam (6) after forming, and phosphatizing and calibrating the cylindrical outer surface (13) of the cam (6).

12. Method according to claim 9,
wherein a threaded bore (20) is formed in the excess length region of the cam journal (18′), and that the threaded bore (20) is used for clamping the cam (6′).

13. Device for milling the contour surfaces of a cam, comprising a clamping vise (21) which clamps the cam (6′) without covering the contour surfaces to be milled,
wherein the clamping vise (21) is configured for clamping a cam tensioning bar (22) and the cam tensioning bar (22) has at least one receiving V-block (23) for the cylindrical outer surface (13) of the cam (6′) and a clamping device for the cam (6′), wherein the clamping direction of the clamping device for the cam (6) is oriented radially with respect to the clamping direction of the clamping vise (21) and against the receiving V-blocks (23) of the cam tensioning bar (22).

14. Device according to claim 13,
wherein the clamping device for the cam (6′) comprises a through bore (24) in the cam tensioning bar (22) disposed in a region of the receiving V-block (23), and a tensioning screw (25) for the threaded bore (20) of the cam (6′).

15. Device for shortening of the cam journal,
wherein the device comprises a sleeve-like clamping element (26) with at least one radial opening (28) and a clamping sleeve (29) with a clamping mandrel (30), wherein the outside diameter and the inside diameter of the cylindrical clamping element (26) correspond to the outside diameter and the inside diameter of the outer swivel element (1) of the clutch, the radial opening (28) is designed for receiving the cam journal (18″), and the clamping mandrel (30) and the clamping sleeve (29) match the cylindrical inner surface (14) of the cam (6′).

16. Device according to claim 15,
wherein the sleeve-like clamping element (26) comprises a stepped through bore (27) with a radial shoulder, and the shoulder of the through bore (27) is configured as an axial limit stop for the cam (6′).
